(19) United States
(12) Patent Application Publication
(10) Pub. No.: US 2007/0225452 A1
(43) Pub. Date: Sep. 27, 2007

(54) Absorbable polyoxaesters containing pendant functional groups

(76) Inventors: Ankur S. Kulshrestha, Jersey City, NJ (US); Kevin Cooper, Flemington, NJ (US); Walter R. Laredo, Hillsborough, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/390,008

(22) Filed: Mar. 27, 2006

(51) Int. Cl. C08L 67/02

(52) U.S. Cl. 525/445; 528/288; 528/293; 528/272

(57) ABSTRACT

Aliphatic polyoxaesters having pendant thiol, carboxylic acid, hydroxyl or amine groups are disclosed. Furthermore, polymers prepared from these functional polyoxaesters are described. The polymers of this invention may be used for an array of medical and surgical applications, for example to produce surgical devices, tissue engineering scaffolds and drug delivery depots.

This application claims benefit to U.S. Nonprovisional Application Docket Number ETH-5266USNP, filed Mar. 27, 2006 incorporated herein by reference in its entirety.

### FIELD OF THE INVENTION

This invention relates to aliphatic polyoxaesters. Specifically, the invention relates to aliphatic polyoxaesters with pendant functional groups and crosslinked polymers thereof.

### BACKGROUND

Functional polymers are macromolecules that possess unique properties and applications. The properties of such materials are often determined by the presence of pendant reactive functional groups that are dissimilar to those in the polymer backbone. These macromolecules have pendant reactive functional groups that can participate in chemical reactions without degradation of the polymer backbone. Examples of functional polymers are polar or ionic functional groups on hydrocarbon backbones or hydrophobic groups on polar polymer chains.

Functional aliphatic polyesters that possess pendant hydroxyl, carboxyl, thiol or amino functional groups are highly sought after because of their numerous applications. Chemical heterogeneity of pendant functional groups often imparts these polyesters with unusual or improved properties due to phase separation, reactivity or associations. For example, carboxylic acid and hydroxyl pendant groups on polyesters increase the hydrophilicity and biodegradation rate of the polymer backbone. They may impart biological activities such as increased adhesion to tissues. The availability of strategically placed pendant functional groups along the polymer backbone facilitates covalent attachment of active pharmaceutical compounds and allows for crosslinking reactions. Polyesters that are water-soluble have pendant functional groups and are bioabsorbable are generally of interest for controlled release and drug delivery systems as well as other biomedical applications. Furthermore, routes to synthesis of novel comb, graft, or network polymers often involve the modification of pendant functional groups.

Bioabsorbable polyoxaesters have been described by Bezwada and Jamiolkowski in U.S. Pat. Nos. 5,464,929; 5,859,150; 5,700,583; 6,074,660; and 6,147,168. These patents describe the class of bioabsorbable polyoxaesters including, copolymers with poly(lactones), polyoxaesters containing amines and amides in the polymer backbone, and their uses in a wide variety of medical applications such as in medical devices, coatings, adhesion prevention, tissue engineering, and as delivery vehicles for active pharmaceutical agents.

In view of the desirability of functionalizing aliphatic polyesters, and the utility of polyoxaesters for medical applications, it would be particularly desirable to develop polyoxaesters with pendant functional groups. Additionally, it would be desirable to fabricate polymers from these functionalized materials so as to further tailor their properties for numerous medical and surgical applications.

### SUMMARY OF THE INVENTION

The invention is an aliphatic polyoxaester comprising the reaction product of an aliphatic polyoxycarboxylic acid and a first diol having pendant thiol, carboxylic acid, hydroxyl or amine groups. The aliphatic polyoxycarboxylic acid has the following formula designated as formula I: HO—C(O)—C(R₁)(R₂)—O—(R₃)—O—C(R₁)(R₂)—C(O)—OH I

wherein each of R₁ and R₂ is independently either hydrogen or an alkyl group containing from 1 to 8 carbon atoms, inclusive, and R₃ is either an alkylene containing from 2 to 12 carbon atoms, inclusive, or an oxyalkylene group of the following formula:
—[(CH₂)_{B}—O—]_{D}—(CH₂)_{E}—
wherein B is an integer from 2 to 5, inclusive, D is an integer from 1 to 12, inclusive, and E is an integer from 2 to 5, inclusive.

The first diol having pendant thiol, carboxylic acid, hydroxyl or amine groups has the following formula designated as formula II:
(X)(R)C((R₄)_{U}—(OH))((R₅)_{V}—(OH) II
wherein each of R₄ and R₅ is independently an alkylene unit containing from 1 to 8 methylene units, inclusive, X is a pendant thiol, amine, carboxyl or hydroxyl group, R is either hydrogen or an alkyl group, and each of U and V is independently an integer in the range of from 0 to about 2,000.

In another aspect of this invention, the invention is a crosslinked polymer comprising the polymerization reaction product of the functional aliphatic polyoxaester described above. Advantageously, the availability of strategically placed pendant functional groups along the polymer backbone facilitates covalent attachment of active pharmaceutical compounds and allows for crosslinking reactions. The crosslinked polymers of this invention that are bioabsorbable are of particular preferred interest and may be used for an array of medical and surgical applications, for example to produce surgical devices, tissue engineering scaffolds and drug delivery depots.

### DETAILED DESCRIPTION OF THE INVENTION

The preferred aliphatic polyoxycarboxylic acids depicted in formula I are 3,6-dioxaoctanedioic acid (R₁ is hydrogen, R₂ is hydrogen, and R₃ is (CH₂)₂), 3,6,9-trioxaundecandioic acid (R₁ is hydrogen, R₂ is hydrogen, and R₃ is oxyalkylene, B is 2, D is 1, and E is 2) and poly(ethylene glycol) diacid (number average molecular weight range from about 250 to about 600) (R₁ is hydrogen, R₂ is hydrogen, and R₃ is oxyalkylene, B is 2, D is from about 7 to about 12, and E is 2). The most preferred aliphatic polyoxycarboxylic acids of formula I are 3,6-dioxaoctanedioic acid and 3,6,9-trioxaundecandioic acid.

The preferred first diols having pendant thiol, amine, carboxyl or hydroxyl groups depicted in formula II are 1-mercapto-2,3-propanediol (X is methylene thiol, R is hydrogen, R₅ is CH₂, U is 0 (therefore there is no R₄), and V is 1), 2-amino-1,3-propanediol (X is amine, R is hydrogen, R₄ is CH₂, R₅ is CH₂, U is 1, and V is 1), bis(hydroxymethyl)butyric acid (X is carboxyl, R is (CH₂)₂, R₄ is CH₂, R₅ is CH₂, U is 1, and V is 1), bis(hydroxymethyl)propionic acid (X is carboxylic acid, R is CH₃, R₄ is (CH₂)₂, R₅ is (CH₂)₂, U is 1, and V is 1) and glycerol (X is hydroxyl, R is hydrogen, R₄ is CH₂, R₅ is CH₂, U is 1, and V is 1. The preferred first diol is one having pendant thiol groups. The most preferred first diol having pendant thiol groups is 1-mercapto-2,3-propanediol.

The polymer produced by reacting the aliphatic polyoxycarboxylic acid (I) with the first diol containing pendant thiol, amine, hydroxyl and carboxyl groups (II) discussed above provides a polymer generally having the formula:
[—O—C(O)—C(R₁)(R₂)—O—(R₃)—O—C(R₁)(R₂)—C(O)—(O)(R₄)_{U}—C(R)(X)—(R₅)_{V}—O—]_{N}
wherein R, R₁, R₂, R₃, R₄, R₅, U and V are defined as described above; and N is an integer from about 1 to about 10,000 and preferably in the range from about 10 to about 1,000 and most preferably in the range from about 50 to about 200.

In a preferred embodiment of this invention, the aliphatic polyoxaester further comprises the reaction product of a second diol having repeat units of the following formula depicted as formula III:
H[—(O—R₆—)_{A}]OH, III
wherein R₆ is an alkylene unit containing from 2 to 8 methylene units, inclusive; and A is an integer in the range from 1 to about 2,000 and preferably from 1 to about 1,000. The preferred second diols are selected from the group consisting of 1,2-ethanediol (R₆ is (CH₂)₂ and A is 1), 1,2-propanediol (R₆ is (CH₂)₂CH₃ and A is 1), 1,3-propanediol (R₆ is (CH₂)₃ and A is 1), 1,4-butanediol (R₆ is (CH₂)₄ and A is 1), 1,5-pentanediol (R₆ is (CH₂)₅ and A is 1), 1,3-cyclopentanediol (R₆ is (CH₂)₅ and A is 1), 1,6-hexanediol (R₆ is (CH₂)₆ and A is 1), 1,4-cyclohexanediol (R₆ is (CH₂)₆ and A is 1), 1,8-octanediol (R₆ is (CH₂)₈ and A is 1), poly(ethylene glycol) (R₆ is (CH₂)₂ and A is an integer in the range from 1 to about 2,000 and preferably from 1 to about 1,000), poly(propylene glycol) (R₆ is (CH₂)₃ and A is an integer in the range from 1 to about 2,000 and preferably from 1 to about 1,000) and combinations thereof. The most preferred second diols are poly(ethylene glycol) and poly(propylene glycol).

The polymer produced by copolymerization of aliphatic polyoxycarboxylic acid (I) with the first diol containing pendant amine, hydroxyl or carboxyl groups (II), and the second diol (III) provides a polymer generally having the formula:
[—O—C(O)—C(R₁)(R₂)—O—(R₃)—O—C(R₁)(R₂)—C(O)—(O)—(R₄)_{U}—C(R)(X)—(R₅)_{V}—O—]_{Y}-[—C(O)—C(R₁)(R₂)—O—(R₃)—O—C(R₁)(R₂)—C(O)—(O—R₆)_{A}—]_{Z}
wherein R, R₁, R₂, R₃, R₄, R₅, R₆, U, V and A are as described above; and Y and Z are an integer in the range from about 1 to about 10,000, preferably in the range from about 10 to about 1,000, and most preferably in the range from about 50 to about 200.

The polymers of the present invention can be prepared by further reacting the aliphatic polyoxycarboxylic acid and first and second diols with lactone monomers as described in U.S. Pat. No. 5,464,929. Suitable lactone-derived repeating units may be generated from the following monomers including but not limited glycolide, d-lactide, l-lactide, meso-lactide, epsilon-caprolactone, p-dioxanone, trimethylene carbonate, 1,4-dioxepan-2-one, 1,5-dioxepan-2-one and combinations thereof. These copolymers may be made in the form of random or block copolymers.

The polymers of the present invention can also be prepared by reacting the aliphatic polyoxycarboxylic acid and first and second diols with polyesters described in U.S. Pat. No. 6,972,315 B2 by transesterification in presence of organometallic catalysts.

The polymerization of the aliphatic functional polyoxaester is preferably performed under melt polycondensation conditions in the presence of an organometallic catalyst at elevated temperatures. The organometallic catalyst is preferably a tin based catalyst, such as stannous octoate. The catalyst will preferably be present in the reaction mixture at a mole ratio of first diol (II), aliphatic polyoxycarboxylic acid (I), and second diol (III) to catalyst ratio of 15,000 to 80,000 to 1. The reaction is preferably performed at a temperature no less than 90 degrees Celsius under reduced pressure. The exact reaction conditions are dependent upon numerous factors including, the desired properties of the polymer, the viscosity of the reaction mixture and the glass transition temperature of the polymer. The preferred reaction conditions can readily be determined by one of skill in the art by assessing these and other factors. Generally, the reaction mixture will be maintained at about 90 to 95 degrees Celsius. The polymerization reaction can be allowed to proceed at this temperature until the desired molecular weight and percent conversion is achieved for the copolymer, which will typically take about 30 minutes to 48 hours. Increasing the reaction temperature generally decreases the reaction time needed to achieve a particular molecular weight.

In another embodiment, copolymers of aliphatic functional polyoxaesters with lactones can be prepared by forming an aliphatic functional polyoxaester prepolymer polymerized under melt polycondensation conditions, then adding at least one lactone monomer or lactone prepolymer. The mixture would then be subjected to the desired conditions of temperature and time to copolymerize the prepolymer with the lactone monomers.

The molecular weight of the polymer as well as its composition can be varied depending on the desired physical properties. However, it is preferred that the aliphatic functional polyoxaester polymers have a molecular weight that provides an inherent viscosity between about 0.2 to about 3.0 deciliters per gram as measured in a 0.1 grams/deciliter solution of hexafluoroisopropanol at 25 degrees Celsius. Those skilled in the art will recognize that the aliphatic functional polyoxaester polymers described herein can also be made from mixtures of more than one diol or dioxycarboxylic acid.

In another embodiment of the present invention, these functional polyoxaester polymers with pendant carboxyl, thiols, hydroxyl, or amine groups can be further derivatized with various functionalities. Non-limiting examples of the derivatization of the polymer of the present invention are depicted schematically below. In this schematic, R_{A} can be a methylene or a PEG spacer unit. F¹, F², F³, and F⁴ represent the acid reactive, amine reactive, thiol reactive, and hydroxyl reactive functional groups, respectively. G represents another terminal functional group where G can be either the same as F¹, F², F³, or F⁴, respectively or G can be a different functional group. T can be greater than or equal to 1. Examples of acid reactive functional groups F¹ include but are not limited to hydroxyl and amino groups. Examples of amine reactive functional groups F² include but are not limited to aldehydes, ketones, isocyanate, epoxy and cyclic dithiocarbonate groups. Examples of thiol reactive functional groups F³ include but are not limited to isocyanate, epoxy and acrylate or methacrylate groups. Examples of hydroxyl reactive functional groups F⁴ include but are not limited to isocyanate, epoxy, acid chloride and cyclic dithiocarbonate groups. For example, a functional polyoxaester with pendant carboxylic acid groups can be reacted with glycidol to form pendant epoxy groups containing absorbable polymer. In another example, a functional polyoxaester with pendant hydroxyl groups or pendant amine groups can be reacted with diisocyanates to form urethane chain extended and isocyanate end functionalized polyoxaesters. In yet another example, a functional polyoxaester with pendant thiol groups can be further derivatized with cyclic dithiocarbonates or epoxy functionalities by either free radical reaction or conjugate addition of pendant thiol groups on the polyoxaester chain with thiol reactive cyclic dithiocarbonate or epoxy compounds. The preferred functional polyoxaester is one that contains pendant thiol groups.

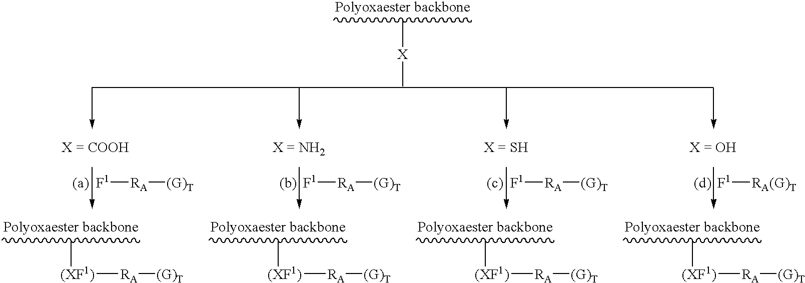

In a preferred embodiment, the functional polyoxaester having pendant thiol groups is further derivatized to have pendant cyclic dithiocarbonate groups. The preferred thiol-reactive dithiocarbonates are 2-thioxo-1,3-oxathiolan-5-yl)methyl methacrylate (TCI America, Portland, Oreg.) and 2-thioxo-1,3-oxathiolan-5-yl)methyl acrylate synthesized as described in Example 6 set forth below. The free radical reaction of the thiol-reactive dithiocarbonate with the aliphatic functional polyoxaester having pendant thiol groups is carried out under an oxygen free atmosphere at 0 to 150 degrees Celsius, preferably 40 to 120 degrees Celsius, for 1 to 24 hours in the presence of initiator such as 2,2′-azobisisobutyronitrile, 2,2′-azobis-2-methylbutyronitile, 2,2′-azobisvaleronitrile and solvent. Suitable solvents are acetonitrile and dioxane. Conjugate addition reaction (also called Michael addition reaction) of the thiol-reactive dithiocarbonate with the aliphatic functional polyoxaester having pendant thiol groups is carried out at physiological temperatures (about 37 degrees Celsius) and under basic conditions (i.e. pH ≧physiological pH (about 7.4) for 15 minutes to 24 hours.

The crosslinked polymers of this invention can be prepared by polymerizing the aliphatic functional polyoxaester having pendant cyclic dithiocarbonate groups in the presence of a dithiocarbonate reactant. Dithiocarbonate reactants can be di- or polyfunctional. Dithiocarbonate reactants include but are not limited to thiols, hydroxyls, and amines. Examples of dithiocarbonate-reactive thiols include proteins containing thiols, such as thiols in cysteine residues, and poly(ethylene glycol)s (PEGs) containing thiols, such as 6-arm sulfydhryl PEG (SunBio Company, Orinda, Calif.) and dipentaerythritol hexakis thioglygolate (DPHTG) (Austin Chemicals, Buffalo Grove, Ill.). Hydroxyls include proteins containing hydroxyls and PEGs containing hydroxyls. Examples of amines that can be used in the present invention include but are not limited to polyethylenimines, polyoxypropylenediamines available under the tradename JEFFAMINES (Huntsman Corporation, Houston, Tx), spermine, spermidine, polyamidaminedendrimers, cysteines, and proteins containing amines. The dithiocarbonate reactants are preferably amines. The preferred amines are spermine and spermidine.

The dithiocarbonate reactant may also be the reaction product of latent reactive moieties and water. The latent reactive moieties can be di- or polyfunctional and include imines, ketimines, and aldimines. Examples of compounds containing latent reactive moieties are N,N-bis(4-methylpentan-2-ylidene)ethane-1,2-diamine (Epikure 3502, Resolution Performance Products, Houston, Tex.), N,N-bis(3-methylbutan-2-ylidene)ethane-1,2-diamine, and N-3-(3-methylbutan-2-ylideneamino)propyl-N-(3-methylbutan-2-ylidene)butane-1,4-diamine. When these latent reactive moieties come in contact with water they become dithiocarbonate reactants.

The crosslinked polymers of the present invention can be obtained by dispersing and mixing the functional polyoxaester with pendant cyclic dithiocarbonate groups with the selected dithiocarbonate reactant at a temperature between room temperature and physiological temperature (about 32 to 60 degrees Celsius). However, one of the various biocompatible solvents including, but not limited to, polyoxyethylene sorbitan fatty acid ester sold under the tradename TWEEN (ICI Americas Inc. Bridgewater, N.J.) and poly(ethylene glycol) may be incorporated, if necessary in a 0.2 to 100-fold amount (by weight) of the co-reactants. A catalyst can also be used to accelerate the reaction if necessary. The most preferred crosslinking reaction conditions is one in which the no solvent or catalyst is added and the reaction temperature ranges is 32-40 degrees Celsius.

The polymers of the present invention resulting from the reaction of the functional polyoxaester having pendant cyclic dithiocarbonate groups and dithiocarbonate reactant can be used in a variety of different pharmaceutical and medical applications. In general, the polymers described herein can be adapted for use in any medical or pharmaceutical application where polymers are currently being utilized. For example, the polymers of the present invention are useful as tissue sealants and adhesives, in tissue augmentation (i.e., fillers in soft tissue repair), in hard tissue repair such as bone replacement materials, as hemostatic agents, in preventing tissue adhesions (adhesion prevention), in providing surface modifications, in tissue engineering applications, in medical devices such as suture anchors, sutures, staples, surgical tacks, clips, plates, and screws; intraocular lenses, contact lenses, coating of medical devices, and in drug/cell/gene delivery applications. The properties of the polymers can be tailored so that the polymers are bioabsorbable. One of skill in the art having the benefit of the disclosure of this invention will be able to determine the appropriate administration of a crosslinked polymer of the present invention.

The Examples set forth below are for illustration purposes only, and are not intended to limit the scope of the claimed invention in any way. Numerous additional embodiments within the scope and spirit of the invention will become readily apparent to those skilled in the art.

### EXAMPLE 1

### Synthesis of Aliphatic Functional Polyoxaester Having Pendant Carboxylic Acid Group

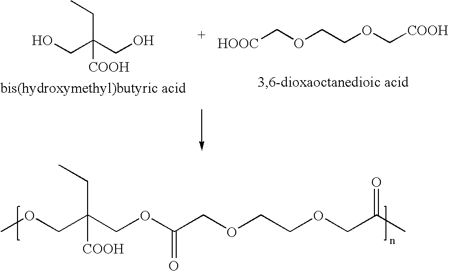

Into a flame dried 100 milliliter round bottom flask was added 5.7 grams (41.9 millimoles) of bis(hydroxymethyl)butyric acid, 7.5 grams (41.9 millimoles) of 3,6-dioxaoctanedioic acid, and 10 milligrams of dibutyltin oxide catalyst. The flask was equipped with magnetic stirring bar and inlet adapter. Vacuum was applied to the flask then it was vented with nitrogen. The flask was lowered into an oil bath maintained at 100 degrees Celsius that rested on a magnetic stirrer. After 1 hour, the temperature of the oil bath was reduced to 95 degrees Celsius and held there for 4 hours. The reaction was allowed to cool to room temperature. The resulting carboxylic acid functionalized polyoxaester was isolated as a thick viscous liquid. The resulting polymer was characterized by ¹³C NMR spectroscopy in dimethylsulfoxide (DMSO), which confirmed the presence of pendant carboxylic acid groups of bis(hydroxymethyl) butyric acid in the repeat unit. ¹³CNMR: 8.43 ppm (—CH₃), 23.32 ppm (—CH₃CH₂—), quaternary carbon (—C—COOH) at 51.71 and 49.92 ppm for pendant —COOH group at the chain end and pendant —COOH group along the polyoxaester backbone. The polymer had an inherent viscosity of 0.06 deciliter/gram (dL/g) as determined in hexafluoroisopropanol (HFIP) at 25 degrees Celsius, and at a concentration of 0.1 grams/deciliter.

### EXAMPLE 2

### Synthesis of Aliphatic Functional Polyoxaester Having Pendant Thiol Groups

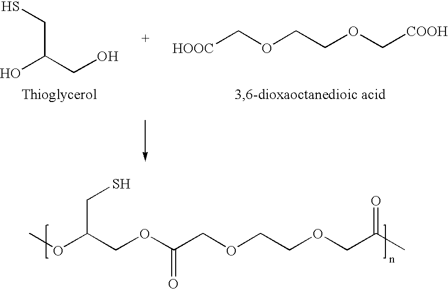

Into a flame dried 100 milliliter round bottom flask was added 12.2 grams (112 millimoles) of thioglycerol (1-mercapto-2,3-propanediol), 20 grams (112 millimoles) of 3,6-dioxaoctanedioic acid, and 10 milligrams of dibutyltin oxide catalyst. The flask was equipped with magnetic stirrer and inlet adapter. Vacuum was applied to the flask then it was vented with nitrogen. The flask was lowered into an oil bath maintained at 90 degrees Celsius that rested on a magnetic stirrer. After 24 hours, the reaction mixture was placed under reduced pressure and allowed to continue another 6 hours. The reaction was allowed to cool to room temperature. The resulting thiol functionalized polyoxaester was isolated as a viscous liquid. The polymer was characterized by iodimetric titration for the presence of pendant thiol groups. The equivalent weight of the polyoxaester was determined to be 287. The free thiol content in the polymer was determined to be 3.5 milliequivalents/gram by iodimetric titration.

### EXAMPLE 3

### Synthesis of Aliphatic Functional Polyoxaester Having Pendant Hydroxyl Groups

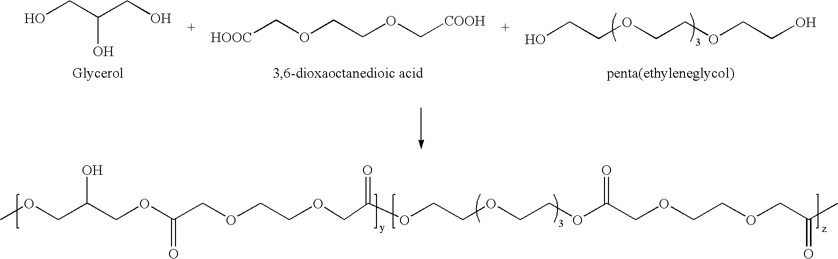

Into a flame dried 250 milliliter round bottom flask was added 100 grams (570 millimoles) of 3,6-dioxaoctanedioic acid and a mixture totaling 570 millimoles of penta(ethylene glycol) and glycerol. In an effort to perform polymerizations with an equimolar ratio of reactive hydroxyl to carboxyl groups, glycerol was assumed to react as a diol in the reactions. Thus a 1:1 molar feed ratio of 3,6-dioxaoctanedioic acid to penta(ethylene glycol) and glycerol was used (see Table 1 below for feed ratios) 10 milligrams of dibutyltin oxide catalyst was added to the reaction mixture. Vacuum was applied to the flask then it was vented with nitrogen. The flask was lowered into an oil bath at 120 degrees Celsius and rested on a magnetic stirrer. After 24 hours, the reaction mixture was placed under reduced pressure and allowed to continue an additional 24 hours. The reaction was allowed to cool to room temperature. The resulting hydroxyl functionalized polyoxaester was isolated as a viscous liquid. The polymer was characterized by ¹³C NMR spectroscopy, which confirmed the presence of pendant hydroxyl groups. The hydroxyl number was determined using the ASTM method E 1899-02 procedure, the inherent viscosity (IV) was determined in hexafluoroisopropanol (HFIP) at 25 degrees Celsius at a concentration of 0.1 grams/deciliter, and weight average molecular weight determined by Size exclusion Chromatography (SEC) in hexafluoroisopropanol (HFIP) relative to polymethylmethacrylate (PMMA) standards.

TABLE 1
Compositions, hydroxyl numbers, molecular weight
averages and intrinsic viscosities of polyoxaesters
with pendant hydroxyl groups.

| | | Observed | | | | |
|---|---|---|---|---|---|---|
| Entry | O:E:G^{a} | EO:GO | | | M_{w}/Mₙ | IV |
| # | Feed ratio | (mol percent) | OH# | M_{w} | (×10⁻³) | (dL/g) |
| 1 | 1:0.95:0.05 | 95:5 | 44 | 10.5 | 1.7 | 0.26 |
| 2 | 1:0.9:0.1 | 90:10 | 48 | 11.0 | 2.9 | 0.29 |
| 3 | 1:0.8:0.2 | 80:20 | 39 | 14.0 | 2.0 | 0.31 |

^{a}O is 3,6-dioxaoctanedioic acid, E is penta(ethylene glycol) and G is glycerol

### EXAMPLE 4

### Synthesis of Aliphatic Functional Polyoxaesters Having Pendant Methacrylate Groups

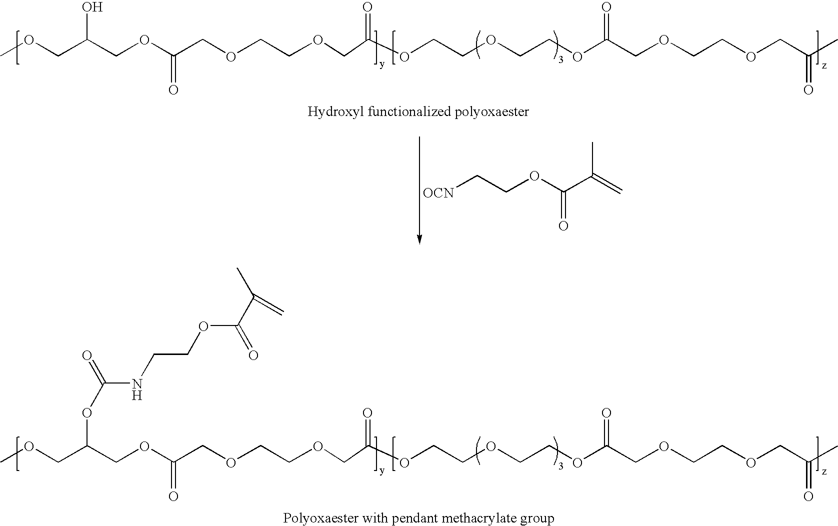

Into a flame dried 250 milliliter round bottom flask equipped with nitrogen inlet was added 10 grams (7.8 milliequivalents) of pendant hydroxyl group containing polyoxaester with a hydroxyl number of 44 from Example 3 (Table 1, Entry 1) and 50 milliliters of anhydrous tetrahydrofuran solvent (Aldrich, Milwaukee, Wis.). 1.22 grams (7.8 milliequivalents) of 2-isocyanatoethyl methacrylate (Aldrich, Milwaukee, Wis.) was added dropwise to this magnetically stirred solution. The reaction was stirred at 40 degrees Celsius for 24 hours. The tetrahydrofuran solvent was removed by rotoevaporation under reduced pressure. The resulting polyoxaesters were characterized by ¹H NMR spectroscopy study of the resulting polyoxaester showed that 91 percent of the pendant hydroxyl groups of the polyoxaester were functionalized with the methacrylate group as determined from the integral ratios of the unsaturated protons of reacted [δ6.1(1H), δ5.5 (1H)] and unreacted [δ6.2(1H), δ5.6 (1H)] 2-isocyanatoethyl methacrylate.

### EXAMPLE 5

### Synthesis of Aliphatic Functional Polyoxaesters Having Pendant Acrylate Groups

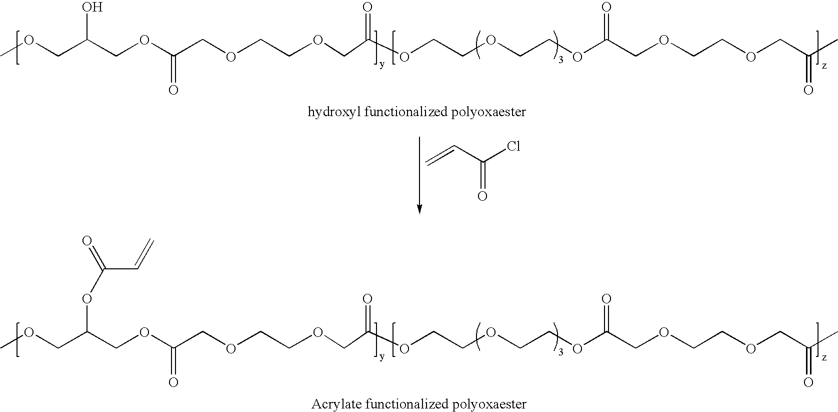

Into a flame dried 250 milliliter round bottom flask equipped with nitrogen inlet and magnetic stirring bar was added 10 grams (7.8 milliequivalents) of aliphatic functional polyoxaester having pendant hydroxyl groups from Example 3, (Table 1, Entry 1) and 50 milliliters of anhydrous tetrahydrofuran solvent (Aldrich, Milwaukee, Wis.). 2.2 grams (24 milliequivalents) of acryloyl chloride (Aldrich, Milwaukee, Wis.) was added dropwise to this magnetically stirred solution. The reaction was stirred at room temperature for 36 hours. The tetrahydrofuran solvent was removed by rotoevaporation under reduced pressure. The resulting polyoxaester was washed with hexanes to remove unreacted acryloyl chloride. ¹H NMR spectroscopy study of the resulting polymer showed that the polyoxaester contained 13 mol percent pendant acrylate groups.

### EXAMPLE 6

### Synthesis of (2-thioxo-1,3-oxathiolan-5-yl)methyl methacrylate)

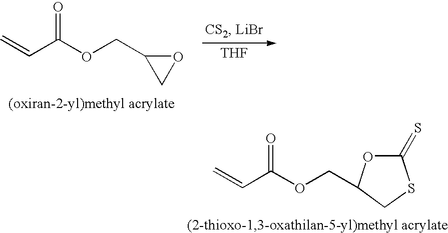

Into a flame dried 2 liter round bottom flask equipped with nitrogen inlet was dissolved 40 grams (312 millimoles) of (oxiran-2-yl)methyl acrylate (Pfaltz and Bauer Co., Waterbury, Conn.) and 1 gram of lithium bromide (Aldrich, Milwaukee, Wis.) in 300 milliliters of anhydrous tetrahydrofuran (Aldrich, Milwaukee, Wis.). 31 grams (410 millimoles) of carbon disulfide were added dropwise to the magnetically stirred solution via a flame dried addition funnel. The reaction was stirred at room temperature for 4 hours then heated to 45 degrees Celsius and continued stirring for 30 hours. The tetrahydrofuran solvent was removed by rotoevaporation under reduced pressure. The resultant product was purified by column chromatography using silica gel (70-230 mesh, 60 angstrom, Aldrich, Milwaukee, Wis.) with 70/30 hexane/acetone as the mobile phase. The resultant dithiocarbonate was isolated as an orange colored liquid. The dithiocarbonate was characterized by ¹H NMR spectroscopy using a Varian Unity Plus Spectrometer. ¹H NMR (400 MHz, CDCl₃), δ=6.5 (dd,1H), δ=6.2 (m,1H), δ=5.9 (dd,1H), δ=5.4 (dd,1H), δ=4.5 (bm,1H), δ=3.5-3.75 (bm,1H), δ=2.9 (m,1H), δ=2.7 (m,1H)

### EXAMPLE 7

### Synthesis of Aliphatic Functional Polyoxaesters Containing Pendant Cyclic Dithiocarbonate Groups

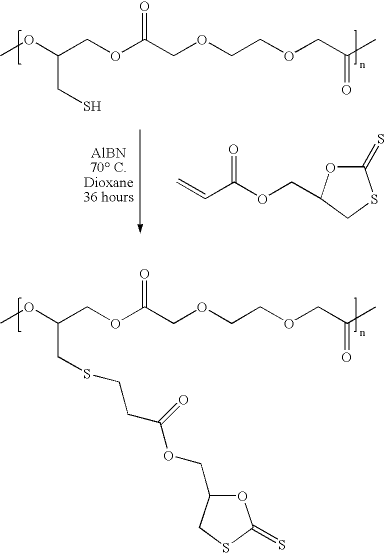

Into a flame dried 500 milliliter round bottom flask equipped with nitrogen inlet were added 20 grams (69.7 milliequivalents) of aliphatic functional polyoxaester having pendant thiol groups from Example 2, 14.2 grams (69.7 milliequivalents) of 2-thioxo-1,3-oxathiolan-5-yl)methyl methacrylate from Example 6, and 300 milliliters of dioxane (Aldrich, Milwaukee, Wis.). 200 milligrams (1.3 millimoles) of azobisisobutyronitrile (AIBN) (Aldrich, Milwaukee, Wis.) initiator was added to the solution with magnetic stirring. The reaction was heated to 70 degrees Celsius and held there for 36 hours. The dioxane solvent was subsequently removed by rotoevaporation under reduced pressure and the resultant dithiocarbonate functionalized polyoxaester was purified by column chromatography using silica gel (70-230 mesh, 60 Angstrom, Aldrich, Milwaukee, Wis.) and 20/80 v/v (volume/volume) hexane/acetone as the mobile phase. The resultant polymer was isolated as an orange viscous liquid and characterized by ¹H NMR where the disappearance of signals at δ=6.5 (dd,1H), δ=6.2 (m,1H) and δ=5.9 (dd,1H) corresponding to the protons of the double bond confirmed the complete consumption and addition of pendant thiols across the double bond of 2-thioxo-1,3-oxathiolan-5-yl)methyl methacrylate.

### EXAMPLE 8

### Crosslinking of Aliphatic Functional Polyoxaester Having Pendant Cyclic Dithiocarbonate Groups from Example 7

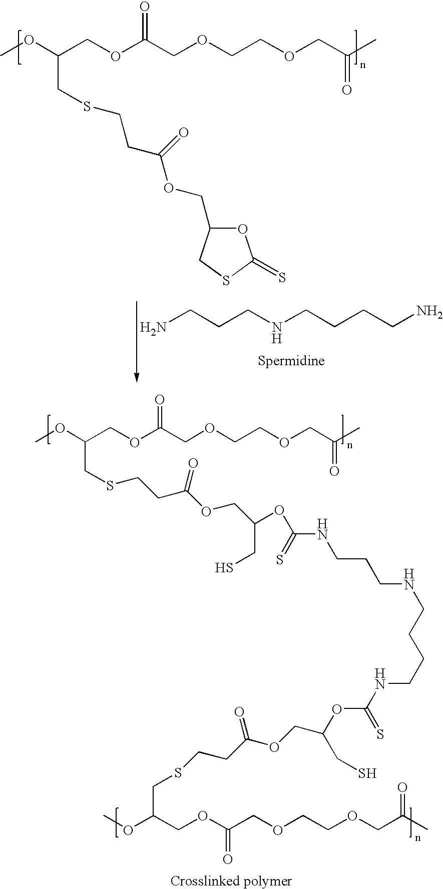

Into a flame dried 100 milliliter round bottom flask was added 2.0 grams (6.9 milliequivalents) of the dithiocarbonate functionalized polyoxaester synthesized in Example 7 and 0.5 grams (6.9 milliequivalents) of spermidine (Aldrich, Milwaukee, Wis.). The reaction mixture was stirred at room temperature for 2 minutes to form a polymeric gel. The polymeric gel was insoluble in hexafluoroisopropanol and was thus characterized to be a crosslinked polymeric gel.

We claim:

1. An aliphatic polyoxaester comprising the reaction product of an aliphatic polyoxycarboxylic acid having the following formula:
HO—C(O)—C(R₁)(R₂)—O—(R₃)—O—C(R₁)(R₂)—C(O)—OH
and a first diol having pendant thiol, carboxylic acid, hydroxyl or amine groups having the following formula:
(X)(R)C((R₄)_{U}—(OH))((R₅)_{V}—(OH)
wherein each of R₁ and R₂ is independently either hydrogen or an alkyl group containing from 1 to 8 carbon atoms, inclusive; and
R₃ is an alkylene group containing from 2 to 12 carbon atoms, inclusive, or an oxyalkylene group of the following formula:
—[(CH₂)_{B}—O—]_{D}—(CH₂)_{E}—
wherein B is an integer from 2 to 5, inclusive;
D is an integer from 1 to 12, inclusive;
and E is an from 2 to 5, inclusive; and
each of R₄ and R₅ is independently an alkylene group containing from 1 to 8 methylene units, inclusive;
X is a pendant thiol, amine, carboxyl or hydroxyl group;
R is either hydrogen or an alkyl group; and
Each of U and V is independently an integer in the range of from 0 to about 2,000.

2. The aliphatic polyoxaester of claim 1 wherein the aliphatic polyoxycarboxylic acid is selected from the group consisting of 3,6-dioxaoctanedioic acid, 3,6,9-trioxaundecandioic acid, and poly(ethylene glycol) diacid; and the first diol is selected from the group consisting of 1-mercapto-2,3-propanediol, 2-amino-1,3-propanediol, bis(hydroxymethyl) butyric acid, and bis(hydroxymethyl)propionic acid and glycerol.

3. The aliphatic polyoxaester of claim 2 wherein the aliphatic polyoxycarboxylic acid is selected from the group consisting of 3,6-dioxaoctanedioic acid and 3,6,9-trioxaundecandioic acid and the first diol is 1-mercapto-2,3-propanediol.

4. The aliphatic polyoxaester of claim 1 further comprising the reaction product of a second diol having the following formula:
H[—(O—R₆—)_{A}]OH,
wherein
R₆ is an alkylene group containing from 2 to 8 methylene units, inclusive; and
A is an integer in the range from 1 to about 2,000.

5. The aliphatic polyoxaester of claim 3 further comprising the reaction product of a thiol-reactive dithiocarbonate.

6. The aliphatic polyoxaester of claim 5 wherein the thiol-reactive dithiocarbonate is selected from the group consisting of 2-thioxo-1,3-oxathiolan-5-yl)methyl methacrylate and 2-thioxo-1,3-oxathiolan-5-yl)methyl acrylate.

7. A crosslinked polymer comprising the polymerization reaction product of the aliphatic polyoxaester set forth in claim 1.

8. A crosslinked polymer comprising the polymerization reaction product of the aliphatic polyoxaester set forth in claim 4.

9. A crosslinked polymer comprising the polymerization reaction product of the aliphatic polyoxaester set forth in claim 5.

10. A crosslinked polymer comprising the polymerization reaction product of the aliphatic polyoxaester set forth in claim 6.
